(19) United States
(12) Patent Application Publication
(10) Pub. No.: US 2022/0249889 A1
(43) Pub. Date: Aug. 11, 2022

(54) Put It Out

(71) Applicant: Humberto Guadalupe Aguilera, Stanwood, WA (US)

(72) Inventor: Humberto Guadalupe Aguilera, Stanwood, WA (US)

(21) Appl. No.: 17/168,193

(22) Filed: Feb. 5, 2021

(51) Int. Cl. A62C 2/04; A47J 37/10; A62C 3/00

(52) U.S. Cl. CPC A62C 2/04; A62C 3/006; A47J 37/108

(57) ABSTRACT

“Put It Out” is an essential device for home cooks and student cooks to professional chefs, young and old to put out stove top grease fires fast, easy, safe, without fear, and no mess. The “Put It Out” will expand your limitations to operate and enjoy your cooking experience even if a stove top grease fire may arise. Easy to use, just turn the burner off and safely place the “Put It Out” over the grease fire and watch the grease fire be smothered and contained

### BACKGROUND

This invention relates to smothering and putting out stove top grease fires in kitchen locations in homes, restaurants, hotels, RV & trailer owners, and any company or business that allows one to cook in its facilities on any type of stove or burner. “Put It Out” is made of fire-resistant material. This invention enhances the safety and use of any stove or burners used in an enclosed environment. This invention can be used on outside grills of various types and sizes.

Many have experienced injuries and damages by attempting to put out grease fires by using the wrong product or equipment because of lacking the understanding of the dangers of grease fires and applying the wrong products which will only increase the dangers of it. With “Put It Out” you can put out the grease fire by suffocating it fast and easy, just by placing “Put It Out” over the pan. It can be used over any burner, stove top, and BBQ grills (with the proper size of “Put It Out”).

### BRIEF SUMMARY OF THE INVENTION

“Put It Out” prevents anyone from injuries or harm from stove top grease fires. “Put It Out” prevents the grease fire from spreading and causing any property damage. “Put It Out” is quick and easy to smother the toughest stove top grease fire. It relieves you the stress of not knowing what to do. “Put It Out” can be placed in a convenient and reachable location near the stove or burner. The present invention seeks to provide a solution (s) to grease fires, which can cause excess property damage, or injuries.

### BRIEF DESCRIPTION OF THE DRAWINGS

FIG. 1. FIG. 1 is a perspective view of the Top of the “Put It Out”.

FIG. 2. FIG. 2 is a perspective view of the Bottom of the “Put It Out”.

FIG. 3. FIG. 3 is a perspective view of the Front of the “Put It Out”.

FIG. 4. FIG. 4 is a perspective view of the Side of the “Put It Out”.

### REFERENCE: NUMBERS IN DRAWINGS

(10) Fire resistant cloth material 1000 degrees or more temperature reading.

(12) All edges double needle hemmed with high heat fiberglass thread.

(14) Grommet

### DETAILED DESCRIPTION AND BEST MODE OF IMPLEMENTATION

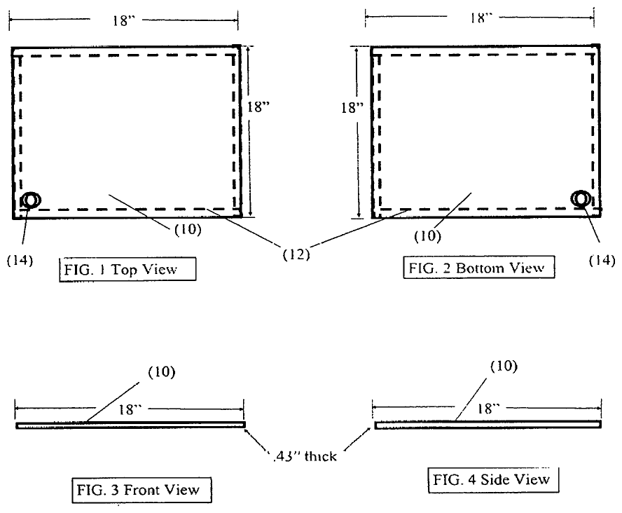

A typical embodiment of the “Put It Out” of the present invention is illustrated in FIG. 1 (Top View), FIG. 2 (Bottom View), FIG. 3 (Front View), and FIG. 4 (Side View).

The “Put It Out” (see FIG.1) Fire-retardant material (10) which is placed over the grease fire. (12) All edges of the fire-retardant material is hemmed with fire retardant thread. One grommet (14) is attached to the one corner of the material for the purpose of hanging the material on a hook.

(10) (see FIG. 1) (see FIG. 2) (see FIG. 3) and (see FIG. 4) of the “Put It Out” is made of a fire-retardant material. (12) Hemmed on all side edges of the fire-retardant material. (14) One grommet is attached to one corner of the material which is used for hanging the material on a hook (see FIG. 1) (see FIG. 2).

1-9. (canceled)

10. The material is made of 100% fiberglass yarn.

11. There are no portables of this size to put out stove top grease fires in the market today.

12. Fabric Finish: Plain (Heat Cleaned), temperature resistance 1000 degrees F., Nominal thickness is 0.036″.

13. Thus the reader will see this “Put It Out” invention provides safety, no mess results and an essential device that can be used by home cooks, student cooks, to professional chefs, and many more.

14. It provides the production of the “Put it Out” (10) (see FIG. 1), (see FIG. 2), (see FIG. 3), and (see FIG. 4) to come in fire retardant such like material, fabrics, and in a variety of shapes, sizes, colors, designs, styles, prints, drawings, art work, and with or without handles to meet the customer's demands.
